(19) United States
(12) Patent Application Publication
(10) Pub. No.: US 2007/0276096 A1
(43) Pub. Date: Nov. 29, 2007

(54) Functional polyolefins useful as metal adhesion promoters

(76) Inventors: John M. Wefer, Newtown, CT (US); Abuzar Syed, Torrington, CT (US)

Correspondence Address: Daniel Reitenbach;CHEMTURA CORPORATION, 199 Benson Road, Middlebury, CT, 06749, US

(21) Appl. No.: 11/804,567

(22) Filed: May 18, 2007

Related U.S. Application Data
(60) Provisional application No. 60/809,041, filed on May 25, 2006.
(60) Provisional application No. 60/846,668, filed on Sep. 22, 2006.

(51) Int. Cl. C08F 261/02

(52) U.S. Cl. 525/298

(57) ABSTRACT

An improved method for producing polypropylenes grafted with acrylic acid by means of reactive extrusion using an organic peroxide is disclosed, wherein the improvement comprises feeding the acrylic acid and the peroxide into the extruder downstream from the point where the polypropylene is introduced;
wherein the acrylic acid is added at a feed rate greater than 25 pounds per hour, the peroxide is added at a feed rate greater than 2 pounds per hour, and the total rate is greater than 500 pounds per hour; and
whereby the PP-g-AA thus produced has a melt flow rate greater than about 200 dg per minute.

I claim the benefit under Title 35, United States Code, § 119 to U.S. Provisional Application No. 60/809,041, filed May 25, 2006 and U.S. Provisional Application No. 60/846,668, filed Sep. 22, 2006, both entitled HIGH FLOW ACRYLIC ACID/POLYPROPYLENE GRAFT USEFUL AS METAL ADHESION PROMOTER.

### BACKGROUND OF THE INVENTION

1. Field of the Invention

The present invention relates to materials comprising functional polyolefins, such as polypropylene grafted with acrylic acid, that improve the adhesion of polypropylene-based polyolefins to metal, and to a method for producing them

2. Description of Related Art

There are a number of commercial applications where polyolefins are required to adhere to metal surfaces. Examples of these types of application include pipe coating, powder coating, and overmolding of a polyolefin onto a metal insert. However, owing to the non-polar nature of polyolefins, these materials do not adhere well to metals. A functionalized polyolefin having polar groups is sometimes used as a polyolefin additive to improve the metal-polyolefin adhesion. Examples of such polar groups include maleic anhydride and acrylic acid.

There are other instances where it is desired to adhere a polyolefin to a non-metallic polar material, such as wood or a polar plastic. In these cases, an additive that is a polyolefin functionalized with acrylic acid or maleic anhydride can improve the adhesion.

The key requirement for these adhesion promoters is that they be compatible with the polyolefin and that during processing they migrate to the polyolefin-metal interface. When the adhesion promoter is at the interface, it is then able to interact with and bond to the metal surface.

Polypropylene grafted with acrylic acid (PP-g-AA) is an example of an adhesion promoter used to improve the bond between polypropylene and metal and between polypropylene-containing thermoplastic elastomers and metal. Commercial PP-g-AA products are available from Chemtura Corporation sold under the trademarks Polybond® 1001 and Polybond 1002. These materials improve the adhesion of polypropylene-based polyolefins to metals, but unfortunately have a relatively low melt flow, and thus are not very efficient at migrating to the polyolefin-metal interface during hot processing, such as overmolding onto a metal insert. Polybond 1001 and Polybond 1002 are polypropylenes grafted with about 6% acrylic acid having Melt Flow Rates of about 40 and 20 dg/min, respectively.

The most common production method for PP-g-AA is via reactive extrusion using an organic peroxide under controlled conditions. In this process, polypropylene is fed into an extruder, often a twin screw extruder, where it is melted. Acrylic acid and an organic peroxide are introduced into the melt, usually by injection. Polymerization and grafting of the acrylic acid takes place in the melt; the melt is usually fed past an extruder zone having a vacuum vent for removing unreacted acrylic acid and peroxide decomposition products, then further transported on the screw to a die where the material is extruded and pelletized. This general process is well-known in the art.

U.S. Pat. No. 3,862,265 and related U.S. Pat. No. 3,953,655 disclose modified polymers, particularly polyolefins, that are said to have improved flow and in some instances improved adhesion properties over that of a polymeric, e.g. polyolefin, base stock used as a starting material. The modified polymers are produced by a controlled reaction often involving degradation in an extruder, in which an initiator is injected under conditions of either maximum distribution or intensive mixing wherein appreciable rheological, e.g., molecular weight distribution, changes in the base polymer occur. In some embodiments, monomers are also grafted to the base stock during the degradation process. No examples are given for preparation of the type of high flow PP-g-AA polymers of the present invention. These patents disclose that certain grafted polyolefin polymers exhibit improved adhesion to polar polymers such as nylon or polyester and improved adhesion to metal nails, but there is no disclosure of the advantage of the high flow PP-g-AA polymers of the present invention when these polymers are desired to be used as additives to otherwise unfunctionalized polyolefins or TPV's, to improve adhesion to metals or polar resins.

U.S. Pat. No. 6,448,343 discloses that the formation of thermoplastic vulcanizates may be accomplished with two polymers, wherein one polymer is grafted, or copolymerized with a carboxylic acid anhydride, which acid anhydride grafted polymer then is reacted with an amino silane, which reacts with the acid anhydride and then cross links.

### SUMMARY OF THE INVENTION

It is an object of the present invention to produce PP-g-AA materials having Melt Flow Rates up to 1000 dg/min., preferably in the range of from about 100 to about 500 dg/min.

Another object of the present invention is the development of an improved material for adhering polypropylene-based polyolefins to polar materials, particularly metals; however, the high melt flow PP-g-AA materials of the present invention are also useful as additives to improve the adhesion of polypropylene-based polyolefins to polar resins such as nylon, polyester, polycarbonate, and other polymers containing polar groups. For example, a thermoplastic vulcanizate (TPV) or other polypropylene-based polyolefin comprising the high melt flow PP-g-AA materials of the present invention will have improved adhesion to a polar resin substrate in an object produced by an overmolding process, compared to a TPV or other polypropylene-based polyolefin containing previously known materials.

Other uses for the high flow PP-g-AA materials of the invention include improved powder coating of metals, improved pipe coating of metallic pipe, improved fabrication into fibers, including those prepared via the Spunbond process, and improved ability to prepare aqueous emulsions.

More particularly, the present invention is directed to an improvement in a method for producing polypropylenes grafted with acrylic acid (PP-g-AA) by means of reactive extrusion using an organic peroxide wherein the improvement comprises feeding the acrylic acid and the peroxide into the extruder downstream from the point where the polypropylene is introduced;

wherein the acrylic acid is added at a feed rate greater than twenty-five pounds per hour, the peroxide is added at a feed rate greater than two pounds per hour, the total weight is greater than 500 pounds per hour; and

whereby the PP-g-AA thus produced has a melt flow rate greater than about 200 dg per minute.

In another aspect, the present invention is directed to a method for increasing the adhesion of polypropylene polymers to polar materials comprising employing as an adhesion promoter a polypropylene grafted with acrylic acid by means of reactive extrusion using an organic peroxide;

wherein the acrylic acid and the peroxide are fed into the extruder downstream from the point where the polypropylene is introduced;

wherein the acrylic acid is added at a feed rate greater than twenty-five pounds per hour, the peroxide is added at a feed rate greater than two pounds per hour, the total weight is greater than 500 pounds per hour; and

whereby the propylene grafted with acrylic acid thus produced has a melt flow rate greater than about 200 dg per minute.

In still another aspect, the present invention is directed to a method for increasing the adhesion of polypropylene to thermoplastic vulcanizates comprising employing as an adhesion promoter a polypropylene grafted with acrylic acid by means of reactive extrusion using an organic peroxide;

wherein the acrylic acid and the peroxide are fed into the extruder downstream from the point where the polypropylene is introduced;

wherein the acrylic acid is added at a feed rate greater than 25 pounds per hour, the peroxide is added at a feed rate greater than 2 pounds per hour, and the total rate is greater than 500 pounds per hour; and

whereby the PP-g-AA thus produced has a melt flow rate greater than about 200 dg per minute.

### DESCRIPTION OF THE PREFERRED EMBODIMENTS

As noted above, the present invention is directed to an improvement in a method for producing polypropylenes grafted with acrylic acid by means of reactive extrusion using an organic peroxide wherein the improvement comprises feeding the acrylic acid and the peroxide into the extruder downstream from the point where the polypropylene is introduced;

wherein the acrylic acid is added at a feed rate greater than twenty-five pounds per hour, the peroxide is added at a feed rate greater than two pounds per hour, the total weight is greater than 500 pounds per hour; and

whereby the PP-g-AA thus produced has a melt flow rate greater than about 200 dg per minute.

The process of this invention can produce very high melt flow PP-g-AA products by controlling the reaction variables in a reactive extrusion process, preferably employing a twin-screw extruder. The key variables comprise the peroxide feed rates, the acrylic acid feed rates, and the total rate.

In accordance with the present invention, the feed rate of the peroxide is greater than two pounds per hour; preferably in the range of from about two to about twenty pounds per hour; more preferably, from about four to about fifteen pounds per hour. The feed rate of the acrylic acid is greater than twenty-five pounds per hour; preferably in the range of from about 25 to about 250 pounds per hour; more preferably, from about 50 to about 150 pounds per hour. The total rate is greater than 500 pounds per hour, preferably in the range of from 500 to 5000 pounds per hour, more preferably in the range of 1000 to 3000 pounds per hour. Total rates over 5000 pounds per hour can be achieved provided the extruder is sized accordingly and the acrylic acid and peroxide feed rates are also proportionally increased.

The acrylic acid employed in the practice of the present invention is preferably glacial acrylic acid.

The peroxides that can be used in the present invention are of a wide variety. The preferred peroxide is 2,5-dimethyl-2,5-di(t-butylperoxy)hexane (Luperox 101, Luperox GmbH). Other peroxides that can be used include, but are not limited to, dicumyl peroxide, t-butyl cumyl peroxide, α,α′-bis(t-butyl peroxy)diisopropyl-benzene, di-t-butyl peroxide, 2,5-dimethyl-2,5-di(t-butyl peroxy)-hexyne-3, diisopropyl peroxide, dilauryl peroxide, 3,3,5-trimethyl1,1-di(tert-butyl peroxy)cylohexane, t-butyl hydrogen peroxide, t-amyl hydrogen peroxide, cumyl hydrogen peroxide, acetyl peroxide, lauroyl peroxide, benzoyl peroxide, ethyl peroxybenzoate, and the like.

The polypropylene used to make the graft copolymers used in the practice of the present invention may be a homopolymer or a copolymer of polypropylene having a melt flow rate of 0.1-100 dg/min (230° C., 2.16 Kg).

The acrylic acid concentration in the PP-g-AA materials of the present invention is typically in the range of from about three to about ten weight percent. Preferably, the acrylic acid is present in a range of from about four to about eight weight percent; more preferably, from about five to about eight weight percent.

The high melt flow PP-g-AA materials of the present invention are useful for adhering propylene polymers, e.g., polypropylene-based polyolefins, to polar materials, particularly metals, such as aluminum, copper, stainless steel, and the like, and polar resins, such as nylon, polyester, polycarbonate, and other polymers containing polar groups. For example, a thermoplastic vulcanizate (TPV) or other polypropylene-based polyolefin containing the high melt flow PP-g-AA materials of the present invention will have improved adhesion to a polar resin substrate in an object produced by an overmolding process, compared to a TPV or other polypropylene-based polyolefin containing previously known materials.

The following description is provided for those who may be unfamiliar with the term “TPV.”

Thermoplastic elastomers (TPEs) exhibit the functional properties of conventional thermoset rubbers, yet they can be melted repeatedly and are therefore suitable for processing in conventional thermoplastic fabrication equipment. The majority of TPEs comprise two phases, one comprising a rubber material (elastomer) that is insoluble in the other, and a flowable thermoplastic material. The rubber material is present as a dispersed phase and the flowable thermoplastic material is the continuous phase.

Although it is in principle not necessary to crosslink the rubber in a TPE, it has proven efficient using crosslinking techniques to obtain better chemical resistance, mechanical properties and a better control of phase separation. Such TPE compositions, where a crosslinking reaction and process is used to achieve phase separation into divided domains, are called Thermoplastic Vulcanizates (TPV). To keep their thermoplastic character, it is essential that only the rubber phase be crosslinked. For an extensive and detailed description and review of TPV technology, see for instance, S. Abdou-Sabet, R. C. Puydak and C. P. Rader in Rubber Chemistry and Technology, vol. 69, pp 476-493, +1996.

The selection of a crosslinking process and chemicals is governed by processing requirements, e.g., reaction rate at the processing temperature; compatibility with the elastomer; side reactions with the thermoplastic; efficiency (number of crosslinks generated by each molecule of crosslinker); absence of undesired reactions; toxicity and hazards; color; and odor.

One example of such TPVs is EPDM/PP described in U.S. Pat. No. 3,130,535. EPDM and polypropylene are mixed intimately in an internal mixer, and a peroxide is added to crosslink the EPDM. Excess peroxide and/or excessively high processing temperature and/or excessively reactive polymers will cause degradation of the polypropylene phase and/or scorch. In contrast, an insufficient amount of peroxide and/or a too low processing temperature and/or a poorly reactive EPDM will cause insufficient crosslinking.

The PP-g-AA materials of the present invention are useful for improving the adhesion of polypropylene polymers to polar materials. The term “polypropylene polymer” as used herein means not only a polypropylene homopolymer, but also a polymer predominantly comprising propylene, particularly a polymer comprising not less than 50% by weight, preferably not less than 80% by weight, of propylene. As examples of the latter polymer, there may be mentioned random copolymers, e.g., propylene-ethylene random copolymer, alternating or segmented copolymers, block copolymers, e.g., propylene-ethylene block copolymer, polymer blends of said polypropylene resin with one or more other thermoplastic resins, such as high-density polyethylene, polybutene-1, poly-4-methylpentene-1, and the like.

The terms “polypropylene homopolymer” and “polypropylene polymer” are also intended to include long chain branched polypropylene.

These polypropylene polymers can be any of those prepared by various methods, e.g., catalytic polymerization using a catalyst that normally contains one or more than one metal of groups IVb, Vb, VIb, or VIII of the Periodic Table. These metals usually comprise at least one ligand, typically oxides, halides, alcoholates, esters, ethers, amines, alkyls, alkenyls, and/or aryls that may be either π or σ-coordinated. These metal complexes may be in the free form or fixed on substrates, typically on activated magnesium chloride, titanium(III) chloride, alumina, or silicon oxide. These catalysts may be soluble or insoluble in the polymerization medium. The catalysts can be used by themselves in the polymerization or further activators may be used, typically metal, alkyls, metal hydrides, metal alkyl halides, metal alkyl oxides, or metal alkyloxanes, said metals being elements of groups Ia, IIa, and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene, or single site catalysts (SSC).

These polypropylenes can be polypropylene random copolymers, alternating or segmented copolymers, or block copolymers comprising one or more co-monomers selected from the group consisting of ethylene, C₄-C₂₀-α-olefin, vinylcyclohexane, vinylcyclohexene, C₄-C₂₀ alkandiene, C₅-C₁₂ cycloalkandiene and norbornene derivatives; the total amount of propylene and the comonomer(s) being 100%.

Further examples of propylene polymers whose adhesion to polar materials can be improved by the PP-g-AA of the present invention include, but are not limited to, propylene/isobutylene copolymer, propylene/butadiene copolymer, propylene/cycloolefin copolymer, terpolymers of propylene with ethylene and a diene such as hexadiene, dicyclopentadiene, or ethylidene-norbornene; propylene/1-olefin copolymers where the 1-olefin is generated in situ; and propylene/carbon monoxide copolymers.

Other examples include, but are not limited to, blends of polypropylene with propylene/ethylene copolymers, propylene/butylene copolymers, polyethylene, e.g. HDPE or LDPE; polybutene, polyisobutylene, poly-4-methylpentene, or alternating or random polyalkylene/carbon monoxide copolymers. These blends preferably comprise at least 50% by weight, relative to the weight of the total blend, of polypropylene.

When blended with polypropylene polymers, the PP-g-AA will normally be present in a range of from about 2 to about 30 weight percent, based on the total weight of the polypropylene polymer and PP-g-AA. Preferably, the PP-g-AA will be present in a range of from about 5 to about 25 weight percent; more preferably, from about 10 to about 20 weight percent.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Process conditions and product properties are given in the Table 1, below. The resin is a polypropylene homopolymer (MFR 4 dg/min at 230° C., 2.16 Kg). The peroxide used is 2,5-dimethyl-2,5-di(t-butylperoxy)hexane (Luperox 101). The acrylic acid is glacial acrylic acid. The extruder is a 92 mm Werner & Pfleiderer twin-screw ZSK, 9-barrel configuration (3240 mm). The polypropylene addition is in barrel 1. The peroxide and acrylic acid injections are in barrel 4. The vacuum vents are at barrels 7 and 8. Barrel temperatures (zones 1-9) are 300/340/370/340/350/350/350/360/360 degrees F., respectively. The die is set at 345° F.

TABLE 1
Process Conditions/Product Properties

| | | Peroxide | Resin | | | | Product |
|---|---|---|---|---|---|---|---|
| | AA feedrate | feedrate | feedrate | Extruder | Extruder | Product | MFR |
| | lb/hr | lb/hr | lb/hr | RPM | torque % | AA % | dg/min |
| INV-1 | 60 | 3.75 | 1400 | 300 | 58 | 5.58 | 195 |
| INV-2 | 60 | 4.50 | 1400 | 300 | 58 | 5.87 | 236 |
| INV-3 | 60 | 5.00 | 1400 | 400 | 42 | 6.06 | 238 |
| INV-4 | 70 | 6.00 | 1400 | 400 | 42 | 6.18 | 424 |

INV-1, INV-2, INV-3, and INV-4 in Table 1 are examples in accordance with the present invention. Polybond 1001 (MFR 40 dg/min.) is used for comparison in the examples below.

Adhesion of PP Homopolymer, PP Copolymer, and TPV to Metal Surfaces

Polybond 1001 and INV-4 (10 and 20%) were blended with polypropylene homopolymers, polypropylene copolymers, and TPV and compounded using a 30 mm ZSK extruder. The compounds were compression molded into films having a thickness of 7-10 mils. Films were cut into one inch wide strips and compression laminated onto two aluminum and stainless steel strips in a heat sealer at about 400° C. for 5-30 seconds. The 180° peel strengths were measured by ASTM D-429 and the data were reported as pounds per linear inch.

The laminated strips of the formulated product and aluminum or stainless steel were tested for peel strength. The control samples did not have any adhesion promoter whereas the test samples each had 10 or 20% of POLYBOND 1001 (comparative examples) or INV-4 (invention examples).

### Adhesion of TPV onto PP Copolymer (Profax SG 702)

For adhesion of TPV to polypropylene via injection overmolding, the samples were dried at 90° C. for three hours prior to molding. The TPV compounds were injection molded into a test bar (6 inches×2.25 inches×0.075 inch) on a BOY 15S injection molder. The test specimens were cut into halves and inserted into the mold cavity away from the gate of a Negri Bossi V-17-110 FA injection molding machine and polypropylene (Profax SG 702) was injection molded to fill the mold at 300-330° F.

The molded samples were cut into test pieces (6 inches×0.5 inch×0.075 inch) and the samples were tested at a speed of two inches/minute for adhesion and reported as peak load (lb force/linear inch).

The blend formulations comprised the following ingredients. The blend compositions and the peel strength data for polypropylene polymer/metal and TPV/metal are tabulated in Table 2.

Polypropylene homopolymer formulations contained Sunoco PP D040W6 (MFR 4 dg/min) from Sunoco Chemicals (80, 90 and 100%), Polybond 1001 or INV-4 (0, 10, 20%) and Naugard B 25 process stabilizer (0.2%) from Chemtura Corporation. Polypropylene copolymer formulations contained Hifax KA 805 A, a heterophasic polypropylene copolymer from Basell (80, 90 and 100%), Polybond 1001 or INV-4 (0, 10, 20%) and Naugard B 25 process stabilizer (0.2%) from Chemtura Corporation. The TPV based formulations contained a polypropylene-based TPV from Teknor Apex, Uniprene 7100 (hardness 50 and 87) (80, 90, and 100%), Polybond 1001 or INV-4 (0, 10, 20%) and Naugard B 25 process stabilizer (0.2%) from Chemtura Corporation.

### Polypropylene Homopolymer and TPV Adhesion

The PP homopolymer from Sunoco (D040W6, MFR 4 dg/min) was compression molded into films having a thickness of 7-10 mils. These films were heat sealed onto films made from the formulated TPVs and peel strengths were measured as per ASTM D-429 and the data reported in pound per linear inch.

### Results: Adhesion with Metal

The polypropylene homopolymer without adhesion promoter showed no adhesion to any metal. The peel strength with aluminum, improved from zero to 0.66 lb (10%) and from 0.1 to 1.43 (lb) (20%) when Polybond 1001 was replaced by the adhesion promoter of the present invention. In the case of stainless steel, there was no adhesion from Polybond 1001 formulated product, but with INV-4 formulated products, the peel strengths improved to 0.31 and 1.62 lb (10 and 20%).

In the case of polypropylene copolymer formulations, there was no adhesion with aluminum or stainless steel without the adhesion promoter, and the adhesion was similar with both Polybond 1001 and INV-4.

The TPV formulations having the high flow adhesion promoter of the present invention showed much improved adhesion compared to Polybond 1001 at both 10 and 20% levels. Without the adhesion promoter, TPV showed no adhesion to either aluminum or stainless steel.

The peel strength was 20 times higher at 10% using the INV-4 adhesion promoter over Polybond 1001 and, similarly, it was above 4-7 times higher at 20%. This result is very significant because the amount of adhesion promoter required to achieve similar adhesion will be significantly reduced or higher adhesion can be obtained at the same adhesion promoter levels.

The data are tabulated in the Table 2 below.

### Results: Adhesion in Homo PP/TPV

In this case, the adhesion was very good good with samples formulated with both Polybond 1001 and INV-4. The films could not be peeled owing to good adhesion and cohesive failure that occurred during the test, i.e., the film broke before peeling. The data shown represent the maximum at the time of failure (breakage). The performance of Polybond 1001 and INV-4 can not be differentiated based on the adhesion data in the table; however, adhesion was strong as shown by the test failure.

TABLE 2
Blend Compositions and Peel Strengths Data

| | | |
|---|---|---|
| Control | Polybond 1001 | INV-4 |

Homo PP (4 MFR)/Metal Adhesion

| Addition | No additive | 10 | 20 | 10 | 20 |
|---|---|---|---|---|---|
| level (%) | | | | | |
| | Peel Strength (lb. pull peak) | | | | |
| Aluminum | No adhesion | No adhesion | 0.1 | 0.66 | 1.43 |
| Stainless Steel | No adhesion | No adhesion | No adhesion | 0.31 | 1.62 |

Heterophasic Copolymer PP (Hifax 805A)/Metal Adhesion

| Addition | No additive | 10 | 20 | 10 | 20 |
|---|---|---|---|---|---|
| level (%) | | | | | |
| | Peel Strength (lb. pull peak) | | | | |
| Aluminum | No adhesion | 8.8 | 3.84 | 7.95 | 6.93 |
| Stainless | No adhesion | 8.67 | 8.21 | 8.56 | 8.41 |
| Steel | | | | | |

Uniprene 7100, Hardness 50/Metal Adhesion

| Addition | No additive | 10 | 20 | 10 | 20 |
|---|---|---|---|---|---|
| level (%) | | | | | |
| | Peel Strength (lb. pull peak) | | | | |
| Aluminum | No adhesion | no test | 3.99 | 3.37 | 12.3 |
| Stainless | No adhesion | no test | 1.94 | 2.79 | 14.76 |
| Steel | | | | | |

Uniprene 7100, Hardness 87/Metal Adhesion

| Addition | No additive | 10 | 20 | 10 | 20 |
|---|---|---|---|---|---|
| level (%) | | | | | |
| | Peel Strength (lb. pull peak) | | | | |
| Aluminum | No adhesion | 0.52 | 3.77 | 10.4 | 14.9 |
| Stainless | No adhesion | 0.403 | 3.16 | 8.82 | 12.53 |
| Steel | | | | | |

TABLE 3
Homopolymer PP and TPV Peel Strength Data

| | |
|---|---|
| Polybond 1001 | INV-4 |

| | | | |
|---|---|---|---|
| 10 | 20 | 10 | 20 |

Peel Strength (lb. pull peak) Uniprene 7100 hardness 50

| | | | |
|---|---|---|---|
| 12.1 | 8.1 | 9.3 | 6.7 |

Peel Strength (lb. pull peak) Uniprene 7100 hardness 87

| | | | |
|---|---|---|---|
| 3.86 | 3.73 | 3.88 | 3.88 |

Adhesion of TPV to Polypropylene via Injection Overmolding

Injection overmolding of soft material, such as TPV, onto hard polymer substrates, such as polypropylene, nylon, PC, PMMA, and ABS, is becoming very common in order to provide a hard/soft combination across a wide range of consumer applications. However, the two polymers are required to adhere to each other and, thus, need a special grade of adhering TPV or an additive, which, when blended into the TPV, helps the adhesion to the rigid substrates.

Table 4 below shows the effect of INV-4 on the adhesion to polypropylene of two TPVs that differ in their softness. Initial data suggest that addition of both Polybond products improves the adhesion to some degree; however, INV-4 performs slightly better than Polybond 1001. The adhesion during the injection overmolding process depends on several factors and the process has not yet been optimized.

A possible explanation for the improved adhesion of TPV containing AA-g-PP to non-polar rigid polypropylene may be the presence of a diffusible, lower molecular weight polypropylene material at the interface, with the polar polyacrylic acid component minimally affecting adhesion as a discontinuous phase. This tends to be supported by the observation that the lower molecular weight material, INV-4, is more effective than Polybond 1001.

TABLE 4
Adhesion of Modified TPV to Polypropylene via
Injection Overmolding

| | Polybond | |
|---|---|---|
| Control | 1001 | INV-4 |

TPV 50 Shore D (Uniprene 7100)

| Addition level (%) | No additive | 10 | 20 | 10 | 20 |
|---|---|---|---|---|---|
| | Peel Strength (PLI) | | | | |
| Polypropylene | 53.5 | 72.8 | 91.8 | 85.5 | 102 |

TPV 87 Shore A (Uniprene 7100)

| Addition level (%) | No additive | 10 | 20 | 10 | 20 |
|---|---|---|---|---|---|
| | Peel Strength (PLI) | | | | |
| Polypropylene | 27.6 | 34 | 66 | 40.7 | 63 |

In view of the many changes and modifications that can be made without departing from principles underlying the invention, reference should be made to the appended claims for an understanding of the scope of the protection to be afforded the invention.

What is claimed is:

1. In a method for producing polypropylenes grafted with acrylic acid by means of reactive extrusion using an organic peroxide, the improvement that comprises feeding the acrylic acid and the peroxide into the extruder downstream from the point where the polypropylene is introduced;
wherein the acrylic acid is added at a feed rate greater than 25 pounds per hour, the peroxide is added at a feed rate greater than 2 pounds per hour, and the total rate is greater than 500 pounds per hour; and
whereby the PP-g-AA thus produced has a melt flow rate greater than about 200 dg per minute.

2. The method of claim 1 wherein the acrylic acid is added at a feed rate in the range of from about 25 to about 250 pounds per hour and the total rate is about 500 to 5000 pounds per hour.

3. The method of claim 1 wherein the acrylic acid is added at a feed rate in the range of from about 50 to about 150 pounds per hour and the total rate is about 1000 to 3000 pounds per hour.

4. The method of claim 1 wherein the peroxide is added at a feed rate in the range of from about 2 to about 20 pounds per hour and the total rate is about 500 to 5000 pounds per hour.

5. The method of claim 1 wherein the peroxide is added at a feed rate in the range of from about 4 to about 15 pounds per hour and the total rate is about 1000 to 3000 pounds per hour.

6. The method of claim 1 wherein the peroxide is 2,5-dimethyl-2,5-di(t-butylperoxy)hexane.

7. The method of claim 5 wherein the peroxide is 2,5-dimethyl-2,5-di(t-butylperoxy)hexane.

8. A method for increasing the adhesion of polypropylene polymers to polar materials comprising employing as an adhesion promoter a polypropylene grafted with acrylic acid by means of reactive extrusion using an organic peroxide;
wherein the acrylic acid and the peroxide are fed into the extruder downstream from the point where the polypropylene is introduced;
wherein the acrylic acid is added at a feed rate greater than 25 pounds per hour, the peroxide is added at a feed rate greater than 2 pounds per hour, and the total rate is greater than 500 pounds per hour; and
whereby the PP-g-AA thus produced has a melt flow rate greater than about 200 dg per minute.

9. The method of claim 8 wherein the polar material is a metal.

10. The method of claim 9 wherein the metal is selected from the group consisting of aluminum, copper, and stainless steel.

11. The method of claim 8 wherein the polar material is a polymer containing polar groups.

12. The method of claim 11 wherein the polar material is selected from the group consisting of nylon, polycarbonate, and polyester.

13. The method of claim 8 wherein the acrylic acid is added at a feed rate in the range of from about 25 to about 250 pounds per hour and the total rate is about 500 to 5000 pounds per hour.

14. The method of claim 8 wherein the acrylic acid is added at a feed rate in the range of from about 50 to about 150 pounds per hour and the total rate is about 1000 to 3000 pounds per hour.

15. The method of claim 8 wherein the peroxide is added at a feed rate in the range of from about 2 to about 20 pounds per hour and the total rate is about 500 to 5000 pounds per hour.

16. The method of claim 8 wherein the peroxide is added at a feed rate in the range of from about 4 to about 15 pounds per hour and the total rate is about 1000 to 3000 pounds per hour.

17. The method of claim 8 wherein the peroxide is 2,5-dimethyl-2,5-di(t-butylperoxy)hexane.

18. The method of claim 16 wherein the peroxide is 2,5-dimethyl-2,5-di(t-butylperoxy)hexane.

19. A method for increasing the adhesion of polypropylene to thermoplastic vulcanizates comprising employing as an adhesion promoter a polypropylene grafted with acrylic acid by means of reactive extrusion using an organic peroxide;
wherein the acrylic acid and the peroxide are fed into the extruder downstream from the point where the polypropylene is introduced;
wherein the acrylic acid is added at a feed rate greater than 25 pounds per hour, the peroxide is added at a feed rate greater than 2 pounds per hour, and the total rate is greater than 500 pounds per hour; and
whereby the PP-g-AA thus produced has a melt flow rate greater than about 200 dg per minute.
